(19) United States
(12) Patent Application Publication
(10) Pub. No.: US 2004/0085396 A1
(43) Pub. Date: May 6, 2004

(54) Micro-miniature fluid jetting device

(76) Inventors: Adam J. Ahne, Lexington, KY (US); John G. Edelen, Versailles, KY (US)

Correspondence Address: LEXMARK INTERNATIONAL, INC., INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/638,859

(22) Filed: Aug. 11, 2003

Related U.S. Application Data
(63) Continuation-in-part of application No. 10/284,066, filed on Oct. 30, 2002.
(63) Continuation-in-part of application No. 10/443,165, filed on May 22, 2003.

(51) Int. Cl. B41J 2/21

(52) U.S. Cl. 347/43

(57) ABSTRACT

A micro-miniature fluid ejecting device configured for ejecting a plurality of ink colors to an object. The device includes a housing having a first end and a second end opposite the first end. The housing contains a logic circuit and sources for at least two inks having different colors. A printhead is attached to the first end of the housing. The printhead is in electrical communication with the logic circuit and the ink sources. The printhead has at least two groups of nozzles for ejecting the at least two inks respectively therefrom. A color sensor is attached to the housing. The color sensor is operatively connected to the logic circuit to sample a color from a sample color source and provide an output for control of the printhead to provide ejection of ink therefrom comprising a mixture of at least two inks that substantially corresponds to the sample color source.

This application is a continuation-in-part of application Ser. No. 10/284,066 filed Oct. 30, 2002, and a continuation-in-part of application Ser. No. 10/443,165 filed May 22, 2003.

### FIELD OF THE INVENTION

The invention relates to micro-miniature fluid jetting devices and in particular to construction and operational techniques for micro-miniature fluid jetting devices.

### BACKGROUND OF THE INVENTION

Micro-miniature fluid jetting devices are suitable for a wide variety of applications including hand-held ink jet printers, ink jet highlighters, and ink jet air brushes. One of the challenges to providing such micro-miniature jetting devices on a large scale is to provide a manufacturing process that enables high yields of high quality jetting devices. Another challenge is to provide fluid jetting devices which are substantially self-contained with respect to control, operation, and use of thereof.

The use of micro-miniature fluid jetting devices for applying single colors to an object such as paper is a relatively simple operation. However, providing a mixture of color inks to an object using a micro-miniature fluid jetting device presents significantly more challenges. The mixture of color inks may be predetermined and unalterable or may be manually “dialed-in” to the device by a user. In that regard, the device may contain separate activation switches for each color ink desired. Such operating techniques for providing a mixture of ink colors are cumbersome and do not always produce the desired result. There continues to be a need for improved micro-miniature jetting devices having enhanced capabilities.

### SUMMARY OF THE INVENTION

With regard to the foregoing and other objects and advantages the invention provides a micro-miniature fluid ejecting device configured for ejecting a plurality of ink colors to an object. The device includes a housing having a first end and a second end opposite the first end. The housing contains a logic circuit and sources for at least two inks having different colors. A printhead is attached to the first end of the housing. The printhead is in electrical communication with the logic circuit and at least two ink sources. The printhead has at least two groups of nozzles for ejecting the at least two inks respectively therefrom. A color sensor is attached to the housing. The color sensor is operatively connected to the logic circuit to sample a color from a sample color source and provide an output for control of the printhead to provide ejection of ink therefrom comprising a mixture of at least two inks that substantially corresponds to the sample color source.

In another embodiment, the invention provides a method for applying one or more inks of different colors to an object. The method includes providing a micro-miniature fluid ejecting device including a housing having a first end and a second end opposite the first end. The housing contains sources for at least two inks having different colors, a logic circuit, a printhead attached to the first end of the housing in electrical communication with the logic circuit and in flow communication with the ink sources, and a color sensor attached to the housing, wherein the color sensor is operatively connected to the logic circuit. The printhead has at least two groups of nozzles for ejecting the at least two inks respectively therefrom. The color sensor is activated with respect to a sample color source to provide an ink color selection signal to the logic circuit. Then the fluid ejecting device is activated to eject one or more inks or a mixture of inks substantially corresponding to the sample color source onto an object in response to the ink color selection signal.

An advantage of the invention is that it provides a unique structure which significantly minimizes the manufacturing costs for micro-miniature fluid jetting devices.

The invention also provides a low cost, micro-miniature color ink ejecting devices which can be readily activated to provide a wide variety of colors to an object. By providing a fluid ejecting device containing a color sensor integral therewith, a user can readily select a color or mixture of colors to eject from the device from a sample color source that can be brought in proximity to the color sensor.

### BRIEF DESCRIPTION OF THE DRAWINGS

Further advantages of the invention will become apparent by reference to the detailed description of preferred embodiments when considered in conjunction with the drawings, wherein like reference characters designate like or similar elements throughout the several drawings as follows:

FIGS. 1-2 are perspective views, not to scale, viewed from opposing ends of a micro-miniature fluid ejector device according to the invention;

FIG. 3 is plan view, not to scale, of dot placement of different color inks on a media using a nozzle plate according to the invention;

FIG. 4 is a top plan view, not to scale, of a nozzle plate according to a first aspect of the invention;

FIG. 5 is a top plan view, not to scale, of a nozzle plate according to the first aspect of the invention containing a barrier layer for separating different fluids from each other;

FIG. 6 is a side elevational view, not to scale, taken along lines 6-6 of FIG. 5;

FIG. 7 is a cross-sectional end view, not to scale, through a barrier layer nozzle plate, and substrate according to one aspect of the invention;

FIG. 8 is plan view, not to scale, of dot placement of different color inks on a media using a nozzle plate according to a second embodiment of the invention;

FIG. 9 is a top plan view, not to scale, of a nozzle plate according to a second aspect of the invention;

FIG. 10 is a top plan view, not to scale, of a nozzle plate according to the second aspect of the invention containing a barrier layer for separating different fluids from each other;

FIG. 11 is a side elevational view, not to scale, taken along lines 11-11 of FIG. 10;

FIG. 12 is a side elevational view, not to scale, taken along lines 12-12 of FIG. 10;

FIG. 13 is a cross-sectional view, not to scale, of a printhead according to the invention;

FIG. 14 is a cross-sectional view, not to scale, of components of a micro-miniature jetting device according to the invention illustrating typical construction thereof;

FIG. 15 is a schematic drawing of a control circuit for operation of a microminiature fluid ejecting device according to the invention; and

FIG. 16 is a plan view, not to scale, of a sample color source for selection of color by a color sensor according to the invention.

### DETAILED DESCRIPTION OF THE INVENTION

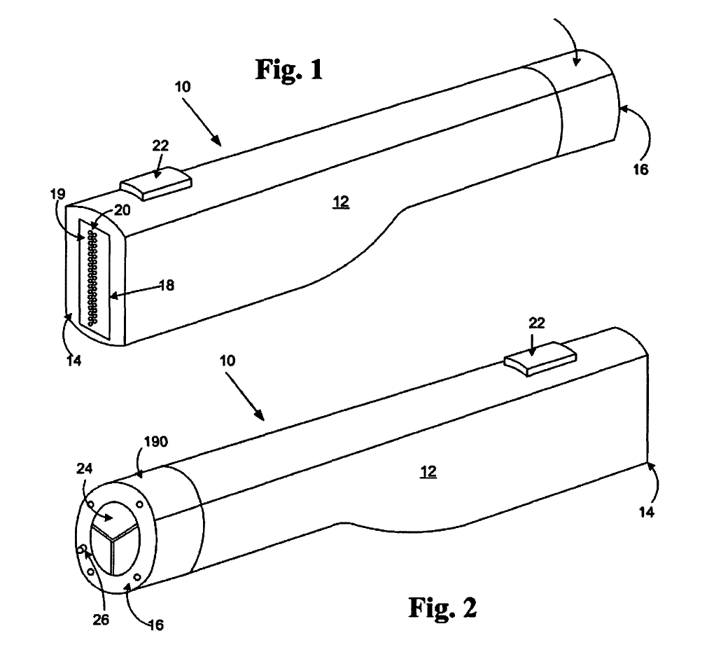

With reference to FIGS. 1-2, important aspects of the invention are illustrated. FIGS. 1-2 are perspective views, not to scale, of a micro-miniature fluid ejecting device 10 configured for ejecting at least two different color inks to an object. The device 10 includes a housing 12 having a first end 14 and a second end 16. The housing 12 is configured for containing at least two different color inks in separate ink reservoirs, a power supply, and a logic circuit described in more detail below, for operating the ejecting device 10. A printhead 18 is attached to the first end 14 of the housing in electrical communication with the logic circuit. The printhead 18 preferably includes a nozzle plate 19 containing at least two groups of nozzle holes 20 for ejecting the at least two different color inks respectively therefrom. An activation button 22 is provided for activating the printhead 18 for ejecting ink.

An important feature of the invention is a color sensor 24 attached to the second end 16 of the housing 12. The color sensor 24 is operatively connected to the logic circuit to sample a color from a sample color source and provide an output for control of the printhead 18 to provide ejection of ink therefrom corresponding to the sample color source. The color sensor 24 may be activated with a separate activation switch such as a plunger type switch 26 integral with the color sensor 24. While it is preferred that the color sensor 24 be fixedly attached to the housing 12, the invention is not limited to such attachment. In the alternative, the color sensor 24 may be removably attached to the housing 12 for sampling a color source remote from the housing 12.

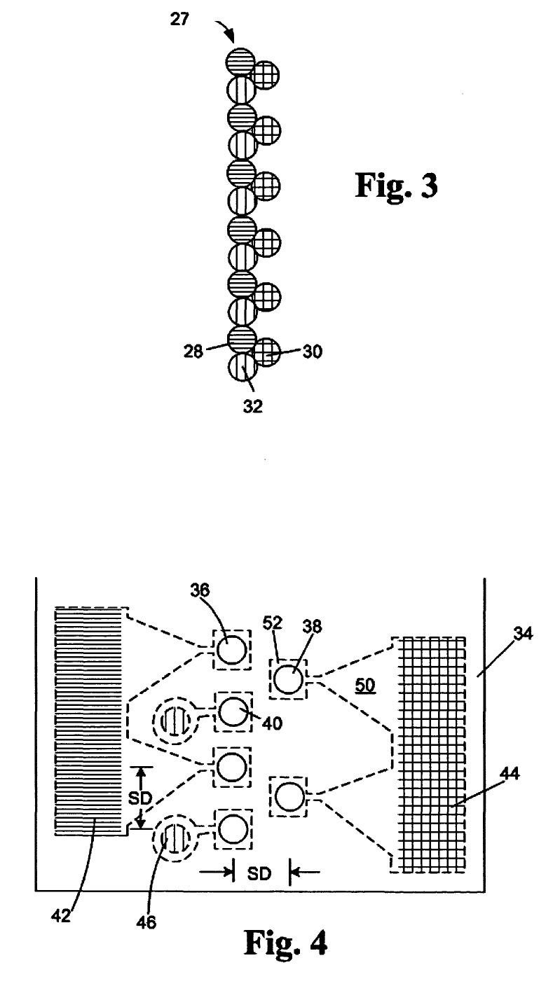

In order to provide a wide variety of colors substantially corresponding to the color source, the printhead 18 is preferably configured for ejecting minute drops of ink of different colors in close proximity between adjacent color drops. A plan view of different color ink dots 27 ejected by a printhead 18 according to the invention is shown in FIG. 3. The ink dots 27 ejected by the printhead 18 include cyan 28, magenta 30, and yellow 32 ink dots.

Ideally, for good color mixing, the different color ink dots 28, 30, and 32 should be closely adjacent one another on the print media as shown in FIG. 3 to reduce the amount of white space between the dots. If the dots 28, 30, and 32 are small enough, individual ink colors will appear as a single color on the print media. Multiple colored dots as small as about 120 microns appear to a human eye to be a single color. Minimizing the white space between the dots will thus sharpen the image and improve color saturation and hue properties of the deposited dots. While the dots 28, 30 and 32 are shown in FIG. 3 as touching one another, there may be a small amount of separation between the dots 28, 30, and 32. It is preferred that the white space or separation between adjacent dots 28, 30, and 32 be less than about 1.1 times the dot diameter on the print media.

In order to provide the colored ink dots 27 as shown in FIG. 3, the printhead 18, preferably includes a nozzle plate 34 as illustrated in FIGS. 4-6. The nozzle plate 34 is preferably made from a polyimide material that may be micromachined to provide flow features therein as described below. A preferred micromachining technique is laser ablation.

FIG. 4 is a top plan view of a nozzle plate 34 according to a first embodiment of the invention. The nozzle plate 34 contains a triad or triangular arrangement of nozzle holes or orifices 36, 38, and 40 wherein adjacent nozzle holes, such as nozzle holes 36 and 38 are dedicated to different color inks. For example, nozzle hole 36 is dedicated to depositing blue ink (C), nozzle hole 38 is dedicated to depositing yellow ink (Y), and nozzle hole 40 is dedicated to depositing magenta ink (M). The nozzle holes 36, 38, and 40 are preferably substantially equidistant from one another. The center to center separation distance SD between adjacent nozzle holes preferably ranges from about 0.8 times the dot size on the print media to about 1.7 times the dot size on the print media.

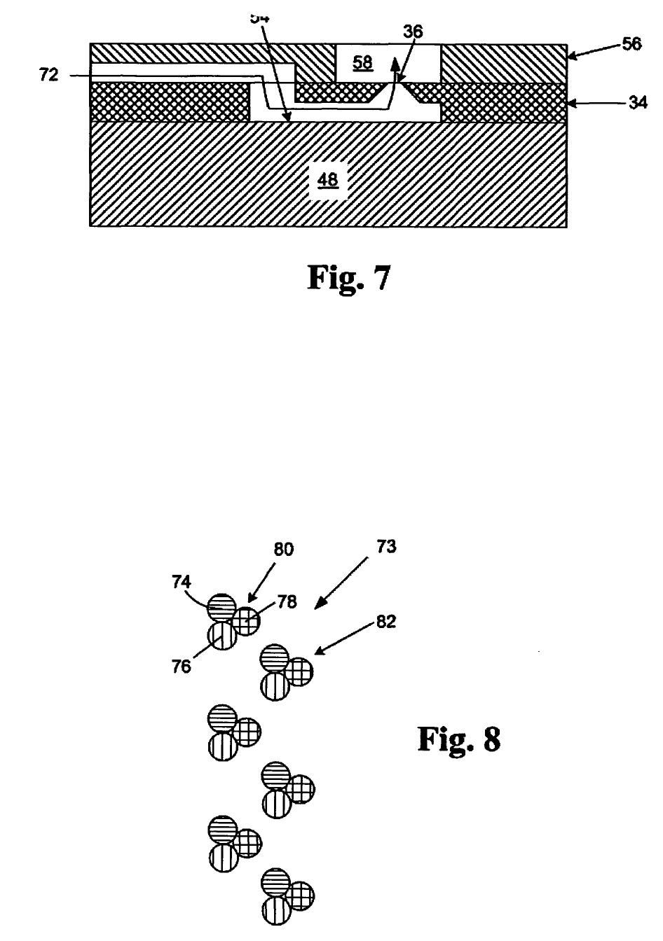

Ink is provided to the nozzle holes 36, 38, and 40 from separate ink supplies through separate fill slots 42, 44, and 46. The ink fill slots 42, 44, and 46 are preferably formed in a semiconductor substrate 48 (FIG. 6) attached to the nozzle plate 34. Ink flows through a supply channel 50 from ink fill slot 44 to an ink chamber 52 for flow through nozzle hole 38. The semiconductor substrate 48 preferably contains a fluid ejection device such as a heater resistor or piezoelectric device for causing ink or other fluids to flow out the ink chamber 52 through nozzle hole 38.

With most drop on demand ink jetting devices, ink occasionally drools out of the nozzle holes and forms a puddle on the nozzle plate when the ejection device is not in use. These puddles of ink should be occasionally wiped off of the nozzle plate so that formation of dried ink sufficient to affect nozzle performance will not occur. However, with the nozzle plate 34 having closely adjacent nozzle holes 36, 38 and 40 for depositing different colors of ink or different fluids, there is a possibility of ink colors mixing on the surface of the nozzle plate 34 when the nozzle holes 36, 38, and 40 drool. If a puddle on the nozzle plate 34 connects different color nozzle holes, a difference in back pressure for a color ink adjacent the puddle may occur. A difference in back pressure may cause ink to flow from one ink feed slot to another thereby cross-contaminating the ink supplies and ruining the jetting device 10.

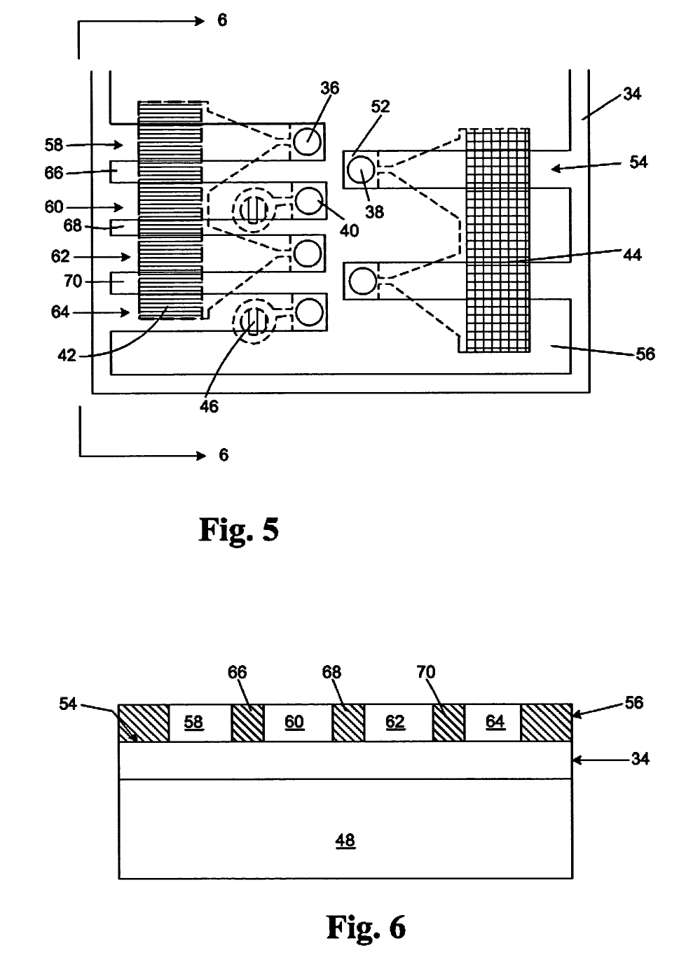

In order to reduce mixing of different colors of inks on a surface 54 of a nozzle plate, a barrier system is preferably provided by barrier layer 56 on the surface 54 of the nozzle plate 34 as shown in FIGS. 5 and 6. The barrier layer 56 is preferably provided by an ink resistant material such as a polyimide film available from DuPont High Performance Materials of Circleville, Ohio under the trade name KAPTON. The barrier layer 56 may be adhered to the surface 54 by a variety of means including adhesives, spin-coating and the like. Channels, such as channels 58, 60, 62, and 64 may be cut into the barrier layer 56 to form individual barrier fingers 66, 68, and 70 between adjacent nozzles to prevent color mixing and to direct puddles away from the nozzle holes.

Because the barrier layer 56 may make it difficult to clean the nozzle plate 34 adequately, it is preferred that the surface 54 of the nozzle plate be coated with a hydrophobic material to reduce wetting of the nozzle plate surface 54. Examples of hydrophobic coatings for nozzle plates include, but are not limited to, polytetrafluoroethylene, polyperfluoroalkoxybutadiene, polyfluorovinylidene, polyfluorovinyl, polydiperfluoroalkyl fumarate, as described in U.S. Pat. No. 5,387,440 to Takemoto et al., and a cross-linked silicone resin, such as the methyltrimethoxysilane manufactured by Dow Corning of Midland, Mich. under the trade name Z 6070 silane as described in U.S. Pat. No. 5,434,606 to Hindagolla et al.

Hydrophilic material may be used as a nozzle plate coating to induce ink to flow away from the nozzle holes. Such wetting materials include, but are not limited to, polyethylene terphthalate (PET), and polycarbonate as described in U.S. Pat. No. 5,434,606 to Hindagolla et al., and titanium dioxide as described in U.S. Pat. No. 6,312,103 to Haluzak.

The barrier layer 56 may also include additional flow channels for ink flow to the nozzles. Such flow channels 72 may be formed through a portion of the barrier layer 56 adjacent surface 54 of the nozzle plate 34 as shown by an end cross-sectional view of the nozzle plate 34, barrier layer 56, and substrate 48 in FIG. 7. Each of the flow channels 72 is preferably connected to a fluid source such as provided by fill slot 42.

In another embodiment, the nozzle holes in a nozzle plate for a jetting device may be arranged in a staggered array of triad nozzles to produce a staggered array 73 of colored ink dots 74, 76, and 78 as shown in FIG. 8. In this case, nozzle triad dots 80 are offset from adjacent nozzle triad dots 82 rather than being aligned in a single column as shown by ink dots 27 in FIG. 3. In this embodiment, the nozzle contains nozzle holes in locations sufficient to produce the staggered array 73 of colored ink dots 74, 76, and 78. In all other respects, the nozzle plate, nozzle holes, ink chambers, ink channels, and ink fill slots are similar to those described with respect to FIGS. 4-6. An advantage of such an arrangement of triad nozzles is that more space is provided on the substrate and in the nozzle plate for wiring and flow paths while maintaining a reduction in white space between the triad dots 80 and 82 as compared to colored dots 27 in FIG. 2.

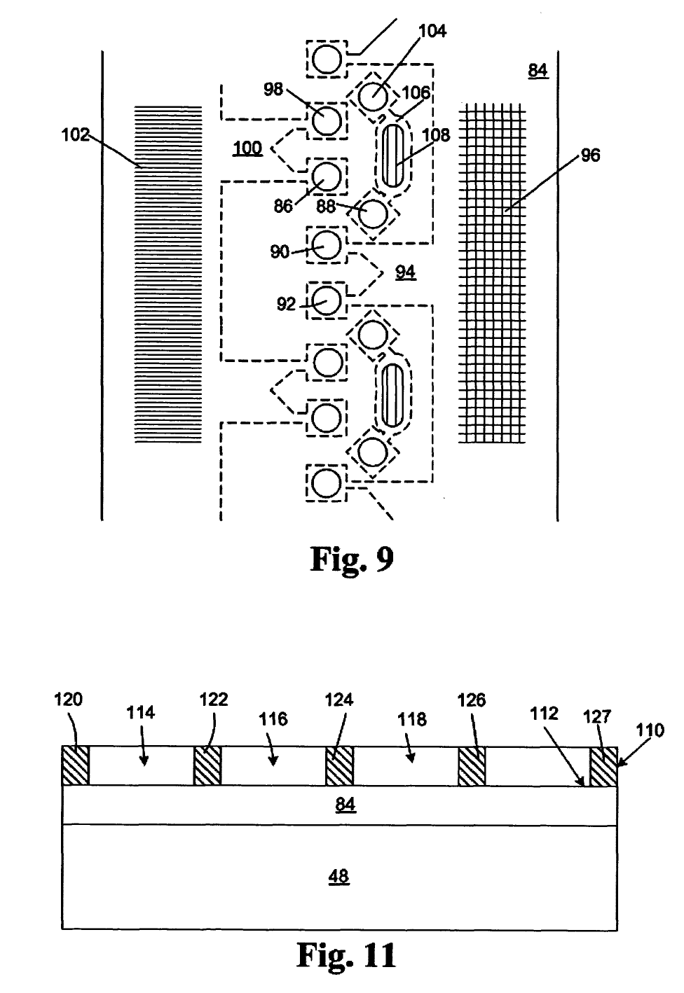

Another arrangement of triad nozzle holes in a nozzle plate 84 is provided in FIGS. 9-12. In this arrangement, instead of repeating CMY CMY CMY triad nozzle holes, the repeating sequence of nozzle holes is CMY YMC CMY YMC so that adjacent nozzle holes can share ink fills slots and flow channels as shown in FIGS. 9-12. With reference to FIG. 9, a nozzle plate 84 is provided containing a triad arrangement of nozzle holes 86, 88, and 90. As before, each of the nozzle holes 86, 88, and 90 is preferably dedicated to a different color ink. However, unlike the embodiment illustrated in FIGS. 4-6, adjacent nozzle holes such as the nozzle hole 90 and a nozzle hole 92 are dedicated to the same fluid or same color ink. In this case, nozzle holes 90 and 92 share a common ink flow channel 94 and a common ink fill slot 96. Likewise, the nozzle hole 86 and a nozzle hole 98 share a common ink flow channel 100 and ink fill slot 102, and the nozzle hole 88 and a nozzle hole 104 share a common ink flow channel 106 and ink fill slot 108.

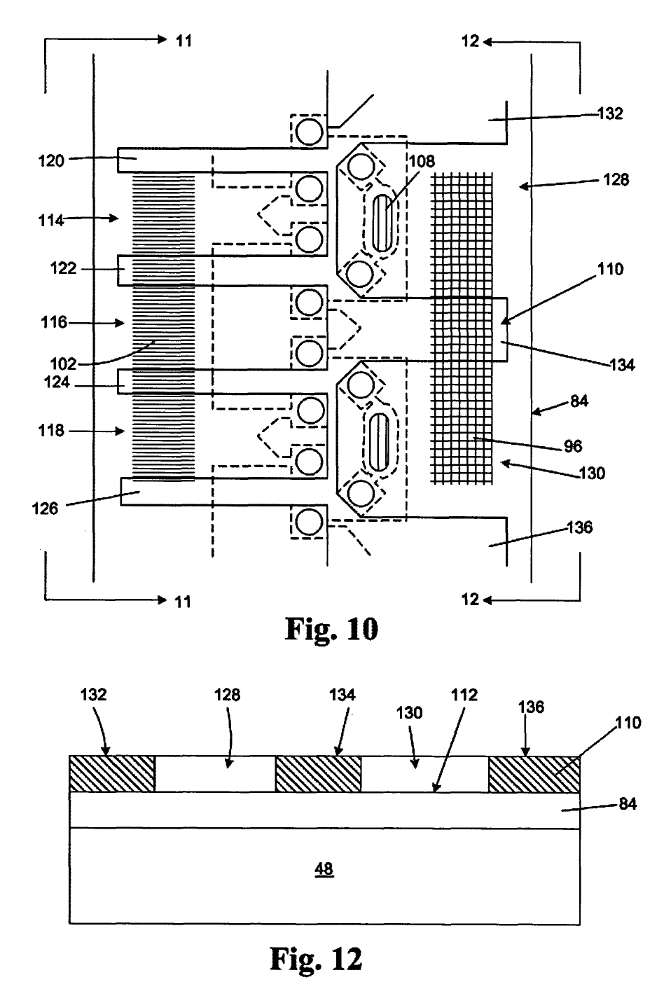

An advantage of the repeating sequence of nozzles CMY YMC CMY YMC is that a simpler barrier layer 110 may be provided on a surface 112 of the nozzle plate as shown in FIGS. 10-12. As before, the barrier layer 110 provides channels 114, 116, and 118 and fingers 120, 122, 124, 126, and 127 (FIG. 11). Channels 128 and 130 and fingers 132, 134, and 136 are shown in FIG. 12 for an opposite side of the nozzle plate 84. Nozzle plate 34 or 84 is a component of printhead 18 as described above. The printhead 18 is attached to the first end 14 of the housing 12 of the ejection device 10 (FIG. 1).

The printhead 18 also includes the semiconductor substrate 48 that contains the activation devices for injecting ink through the nozzle plate 34 or 84. As shown in FIG. 13, the nozzle plate 34 is attached to the substrate 48 to provide the printhead 18. In FIG. 13, the ejection device for ejecting ink through nozzle hole 38 is a thermal type fluid ejection device.

A typical thermal type fluid ejection device 138 is provided by multiple thin film insulative and conductive materials deposited on a semiconductor substrate 140 as illustrated, for example, in FIG. 13. The substrate 140 preferably provided by a silicon material containing a thermal barrier layer 142 and a resistive material layer 144. The resistive layer 144 may be made from a variety of materials including but not limited to tantalum/aluminum alloys. A first metal conductive layer 146 such as aluminum, copper, or gold provides anode 148 and cathode 150 connections to the resistive layer 144. In order to protect the ejecting device 138 from corrosion and erosion, a dual layer including a passivation layer 152 made of silicon nitride, silicon carbide, or a combination of silicon nitride and silicon carbide, and a cavitation layer 154 made of tantalum is preferably provided. A dielectric layer 156 is preferably provided over the first metal conductive layer 146 to insulate layer 146 from a second metal conductive layer 158. Like the first metal conductive layer 146, the second metal conductive layer 18 may be made of aluminum, copper, gold and the like. A nozzle plate, such as nozzle plate 34 described above is attached to the substrate 48 to provide ink chamber 52 for ink to be ejected by ejecting device 138 through nozzle hole 38.

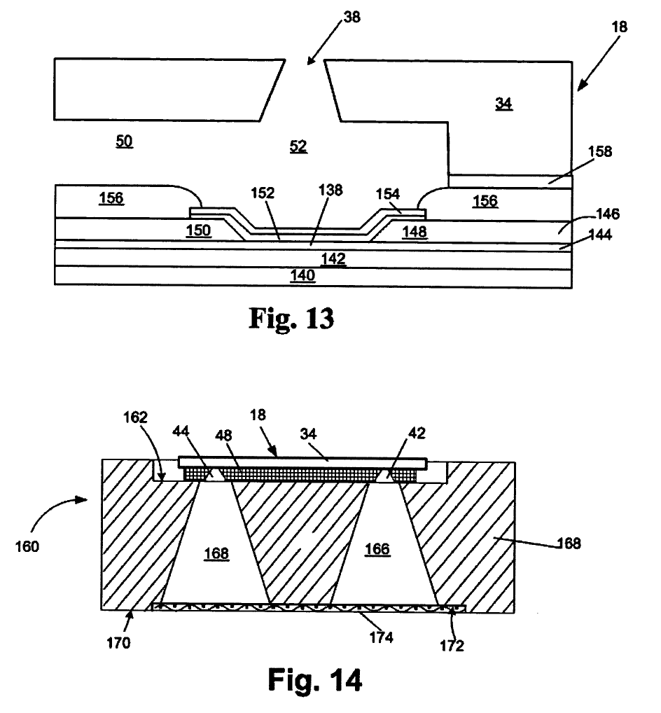

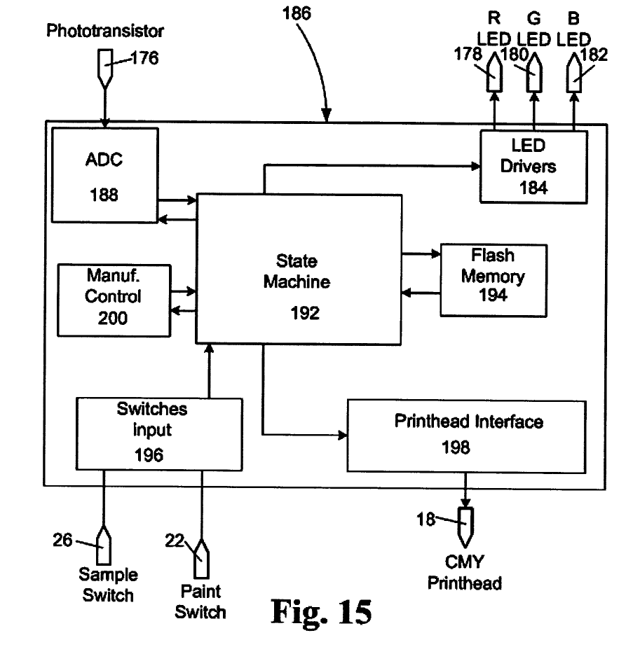

The printhead 18, including the nozzle plate 34 and substrate 48 is preferably attached to a printhead structure or head box 160 on the first end 14 of the housing 12. A cross-sectional view of a preferred head box is shown in FIG. 14. The head box 160 is preferably made from a wide variety of non-conductive materials, including, but not limited to, ceramics, plastics, wood, plastic coated metal, and the like. A preferred material for the head box 160 is a standard material for a surface mounted integrated circuit (IC) package such as a high softening point thermoplastic material.

In keeping with the desire to provide a low cost micro-miniature fluid jetting device, the overall size of the head box 160 is relatively small. Preferably, the overall dimensions of the head box 160 are from about 6 to about 12 millimeters in length, from about 3 to about 7 millimeters in width, and from about 2 to about 4 millimeters in thickness.

The head box 160 preferably includes a printhead pocket 162 for attaching the printhead 18 therein. The depth of the printhead pocket area 162 preferably ranges from about 1.0 to about 2.0 millimeters in depth. Fluid slots 164 and 166 are provided in a head box body 168 for providing flow of ink from ink reservoirs in the housing 12 to the ejecting devices such the device 138 on the substrate 48. The dimensions of the fluid slots 164 and 166 in the head box body 168 are not critical to the invention provided the fluid slots 164 and 166 provide for sufficient flow of ink to the ejecting devices. Preferred dimensions of the fluid slots 164 and 166 range from about 4.5 to about 5.5 millimeters in length and from about 1.0 to about 1.5 millimeters in width.

A second surface 170 of the head box 160 opposite the printhead pocket 162 preferably includes a recessed portion defining a filter pocket area 172. It is preferred that a filter 174 be attached in the filter pocket area 172 of the head box body 168 before the head box 160 leaves a clean room area where the printhead 18 is attached to the head box 160. In an alternative design, a filter may be attached to the semiconductor substrate 48 between the substrate 48 and the chip pocket 162 of the head box 160, or a filter may be integrated into the nozzle plate 34 between the substrate 48 and the nozzle plate 34. A nozzle plate 34 containing an integrated filter is described, for example, in U.S. Pat. No. 6,045,214 to Murthy et al. entitled “Ink jet printer nozzle plate having improved flow feature design and method of making nozzle plates,” the disclosure of which is incorporated by reference as if fully set forth herein.

Reference is now made to the color sensor 24 on the second end of the microminiature fluid ejecting device 10. The color sensor 24 is preferably a three-element color sensor such as a color sensor available from Laser Components Instrument Group, Inc. of Wilmington, Mass. under the trade name MCS3AT/BT. Such a color sensor 24 includes three Si-PIN photo diodes integrated on a chip. The photo diodes are provided as segments of a ring with a diameter of about 2 millimeters. A phototransistor 176 is located near a red LED 178, a green LED 180, and a blue LED 182 (FIG. 15) so that light reflected from each LED 178-182 will strike the phototransistor 176. The LEDs are controlled by LED drivers 184 in a digital ASIC 186. The phototransistor 176 is connected to an analog to digital converter (ADC) 188 in the digital ASIC 186. The phototransistor 176 and LED's 178-182 are mounted in an optical housing 190 (FIG. 1) so that the LED's 178-182 will be at the proper operating distance when the housing 190 is pressed against a surface. The housing 190 is configured to block ambient light when the sensor 24 is pressed against a surface.

A sample switch such as the switch 26 is located on the housing 190 such that the switch 26 is depressed when the housing 190 is pressed against a surface. A state machine 192 controls the ADC 188 and LED's 178-182, as well as an internal flash memory 194 comprising non-volatile RAM, a switch interface 196, and a printhead interface 198. The state machine 192 can be controlled externally through a manufacturing control interface 200.

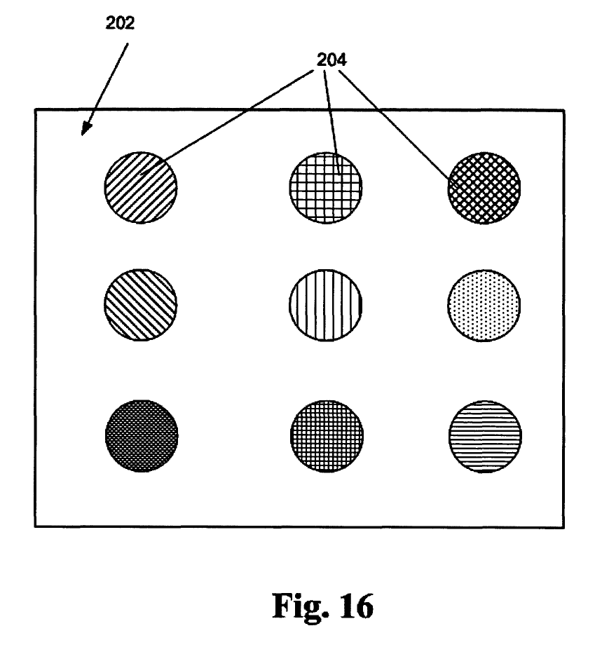

In operation, a user presses the optical housing 190 against a surface to trigger color sampling. The surface may be a color palette 202 as shown in FIG. 16 containing sample color sources 204 of different colors, or any colored object the user wishes to duplicate the color thereof. As the sample switch 26 is depressed, the switch 26 signals the state machine 192 to begin the sample process. Each LED 178-182 is turned on individually, and a phototransistor ADC reading provided by ADC 188 is stored by the state machine 192 in the non-volatile flash memory 194. Thus, an RGB value is generated and stored in the flash memory 194 for later use.

When activation button 22 is depressed by the user, the micro-miniature jetting device 10 will jet ink from the printhead 18 corresponding to the stored RGB value. As the button 22 is pushed, the state machine 192 loads the previously stored RGB value from flash memory 194, and uses the RGB value as an index for input into a threedimensional lookup table also stored in flash memory 194. The lookup table contains CMY values for output to the printhead interface 198 for selective operation of ejecting devices 138 on the printhead 18.

The manufacturing control interface 200 is used during manufacturing to calibrate the color sensor 24. A manufacturing computer can turn on each LED 178-182, read the ADC 188, and write to the flash memory 194, all through the manufacturing control interface 200. Various calibration colors are sampled by the color sensor 24, and the resulting RGB values are used by the manufacturing computer to generate a custom lookup table for the sensor 24. The lookup table is stored in the flash memory 194.

It is contemplated, and will be apparent to those skilled in the art from the preceding description and the accompanying drawings, that modifications and changes may be made in the embodiments of the invention. Accordingly, it is expressly intended that the foregoing description and the accompanying drawings are illustrative of preferred embodiments only, not limiting thereto, and that the true spirit and scope of the present invention be determined by reference to the appended claims.

What is claimed is:

1. A micro-miniature fluid ejecting device configured for ejecting a plurality of ink colors to an object, the device comprising:
a housing having a first end and a second end opposite the first end, the housing containing a logic circuit and sources for at least two inks having different colors,
a printhead attached to the first end of the housing, the printhead being in electrical communication with the logic circuit and the at least two ink sources, and having at least two groups of nozzles for ejecting the at least two inks respectively therefrom, and
a color sensor attached to the housing, wherein the color sensor is operatively connected to the logic circuit to sample a color from a sample color source and provide an output for control of the printhead to provide ejection of ink therefrom comprising a mixture of at least two inks that substantially corresponds in color to the sample color source.

2. The micro-miniature fluid ejecting device according to claim 1, wherein the color sensor is attached to the second end of the housing.

3. The micro-miniature fluid ejecting device according to claim 1, wherein the housing contains at least three inks having different colors.

4. The micro-miniature fluid ejecting device according to claim 3, wherein the printhead contains at least three groups of nozzles for ejecting the at least three inks having different colors.

5. The micro-miniature fluid ejecting device according to claim 4 wherein groups of three adjacent nozzles are arranged in a triad orientation and wherein at least two adjacent nozzles in said triad orientation are coupled to two different color inks.

6. The multi-fluid ejecting device of claim 5 wherein a center-to-center separation distance between adjacent nozzles in each of said groups of three adjacent nozzles ranges from about 0.8 to about 1.7 times a droplet size ejected from said nozzles.

7. The micro-miniature fluid ejecting device according to claim 1, wherein the groups of nozzles are arranged in two or more substantially linear arrays on the printhead.

8. The micro-miniature fluid ejecting device according to claim 1, wherein the color sensor is removably attached to the housing.

9. A method for applying one or more inks of different colors to an object comprising,
providing a micro-miniature fluid ejecting device including a housing having a first end and a second end opposite the first end, the housing containing sources for at least two inks having different colors, a logic circuit, a printhead attached to the first end of the housing in electrical communication with the logic circuit and in flow communication with the ink sources, the printhead having at least two groups of nozzles for ejecting the at least two inks respectively therefrom, and a color sensor attached to the housing, wherein the color sensor is operatively connected to the logic circuit,
activating the color sensor with respect to a sample color source to provide an ink color selection signal to the logic circuit, and
activating the fluid ejecting device to eject one or more inks or a mixture of inks substantially corresponding to the sample color source onto an object in response to the ink color selection signal.

10. The method of claim 9 further comprising providing a color sample pallet as the color sample source wherein the color sensor is activated with respect to the color sensor pallet.

11. The method of claim 9 wherein the color sensor is attached to the second end of the housing.

12. The method of claim 9, wherein the housing contains at least three inks having different colors.

13. The method of claim 9 wherein groups of three adjacent nozzles are arranged in a triad orientation and wherein at least two adjacent nozzles in said triad orientation are coupled to two different color inks.

14. The method of claim 9 wherein the sample color source is a colored object and wherein the step of activating the color sensor comprises contacting the color sensor with the colored object to provide the ink color selection.
